(19) United States
(12) Patent Application Publication
(10) Pub. No.: US 2017/0159332 A1
(43) Pub. Date: Jun. 8, 2017

(54) DOOR HANDLE ASSEMBLY FOR A VEHICLE

(71) Applicant: Andreas Beck, Bochum (DE)

(72) Inventor: Andreas Beck, Bochum (DE)

(73) Assignee: Huf Huelsbeck & Fuerst GmbH & Co. KG, Velbert (DE)

(21) Appl. No.: 15/291,783

(22) Filed: Oct. 12, 2016

(30) Foreign Application Priority Data
Dec. 7, 2015 (DE) 10 2015 121 222.6
Dec. 21, 2015 (DE) 10 2015 122 359.7

(51) Int. Cl. E05B 81/90; E05B 79/20; E05B 79/06; E05B 85/06; E05B 81/78; E05B 85/16

(52) U.S. Cl. CPC E05B 81/90; E05B 81/78; E05B 85/16; E05B 79/06; E05B 85/06; E05B 79/20

(57) ABSTRACT

The invention relates to a door handle assembly of a motor vehicle, having a mount that can be attached to the inside of a door, a handle that can be disposed on the outside of the door, a door latch, which can be opened both mechanically as well as electrically, and a sensor electronics assembly for detecting an actuation of the handle. A mechanical retaining element exerts a retaining force on a second longitudinal end of the handle, and retains the handle in a non-pivoted position. The sensor electronics assembly electrically opens the door when an actuation with a force that is lower than the return force is detected, and the handle remains un-pivoted thereby. The handle can be pivoted into an emergency actuation position when the handle is actuated with a force that is greater than the retaining force, in which case the handle mechanically opens the door.

### BACKGROUND

The invention relates to a door handle assembly of a motor vehicle, having a mount that can be attached to the inner surface of a door or hatch of the motor vehicle and which is designed in the manner of a frame, a handle that can be disposed on the outer surface of the door or hatch of the motor vehicle, which the user can grasp, a door latch of the door or hatch of the motor vehicle, which can be activated and opened both mechanically as well as electrically, and a sensor electronics assembly for detecting an actuation of the handle caused by a user, wherein a first longitudinal end of the handle is pivotally supported on the mount, and a second longitudinal end of the handle is coupled to the mount such that it can be pivoted away from the mount.

Door outer handles have handles as a part of the overall door handle assembly, which can be grasped or pulled by a user. In this manner, the user can exert force on the handle, in order to open the door or to close it, or to move the handle over its pivotal range. Vehicle door handles are provided with coupling means that enable the vehicle door handle to be installed on the vehicle door.

Vehicle door handles of this type are known and available in different designs. As such, door handle assemblies having moveable handles, as well those having so-called stationary handles, are known. While with moveable handles, a handle part of the vehicle door handle assembly that is to be grasped by a user from below or behind is pivoted or moved in a translatory manner through the application of force, the handle in a stationary door handle cannot be pivoted or moved in a translatory many. With vehicle door handles having stationary handles, the handle is substantially immobile with respect to the door. With door handles having stationary handles, due to the absence of a mechanical adjustment path, no continuous mechanical functional chain from the door handle to a door latch is formed. Instead, the door latch is activated electrically, as a function of a detected actuation, such that the mechanical hardware can be reduced, and costs and weight can be saved in the door handle assembly.

Electrically activated door latches are used in combination with such stationary handles, and vehicle door handle assemblies. Such electrically activated door latches are known in general under the term “E-latch” (“electronic latch”). One example of such a door system is described in EP 0 584 499 A1.

The manner in which vehicle door handle assemblies having stationary handles detect the actuation of the handle has been solved in the prior art in a variety of ways. Switches or capacitive sensors may be used on or in the vehicle door handle. Inductive sensors may also be used. As set forth in the invention, the term “sensor electronics assembly” can be understood to mean a switch, a button, a capacitive sensor, or an inductive sensor, which serves to detect an actuation of the handle caused by a user.

With closing systems that can be activated and opened electrically, the problem exists that, when there is a system malfunction or power failure, access to the motor vehicle remains blocked.

The fundamental object of the invention is therefore to create a solution, which provides a door handle assembly in a structurally simple manner, which can be manufactured inexpensively, and which can be easily installed, with which access to the interior of the motor vehicle is nevertheless enabled in the event of a system malfunction (e.g. as a result of an vehicle accident) or a power failure (e.g. resulting from a weak battery).

### BRIEF SUMMARY

This objective is achieved with a door handle assembly of a motor vehicle having the features of claim 1.

As with the generic door handle assemblies described above, the door handle assembly according to the invention also has a mount that can be attached to the inside of a door or hatch of the motor vehicle, and which is designed in the manner of a frame, a handle that can be disposed on the outside of the door or hatch of the motor vehicle, which can be grasped by a user, a door latch of the door or hatch of the motor vehicle, which can be activated and opened both mechanically as well as electrically, and a sensor electronics assembly for detecting an actuation of the handle caused by a user. In doing so, a first longitudinal end of the handle is pivotally supported on the mount, and a second longitudinal end of the handle is coupled to the mount such that it can be pivoted away from the mount.

A mechanical retaining element that is attached to the mount exerts a predetermined retaining force toward the mount on the second longitudinal end of the handle, such that the retaining element retains the handle in an un-pivoted, normal actuation position. A user can actuate the handle when it is in the normal actuation position, without pivoting the handle thereby. When an actuation of the handle by a user with a normal actuation force directed away from the mount, which is less than the predetermined return force, is detected, the sensor electronics assembly opens the door or hatch electrically. Because the normal actuation force is less than the predetermined return force, the handle remains disposed in its normal actuation position. The handle is thus not pivoted outward in a normal actuation by a user, because the typical normal actuation force is lower than the return force of the retaining element. The handle gives the impression of a stationary handle to the user, as is desirable with the present invention.

In the event of an emergency, either because of a system malfunction or a power failure, there is still the possibility of an emergency opening with the door handle assembly according to the invention. This is enabled because, when the handle has been actuated with an emergency actuation force directed away from the mount, which force is greater than the predetermined return force, the handle can be pivoted outward, wherein the pivotal movement of the handle mechanically opens the door or hatch. It is to be understood that the emergency actuation force must be significantly greater than the normal actuation force, such that a user actually exerts sufficient force on the handle, and pulls it toward him, only in an emergency. Thus, the door handle assembly according to invention cannot be classified as belonging to either the group of door handle assemblies having moveable handles, or the group of door handle assemblies having stationary handles. On the contrary, the door handle assembly according to the invention makes use of aspects from both groups, and is therefore distinguished by a pseudo-stationary handle, which remains stationary in its normal actuation position during normal actuation, and which can only be pivoted outward into an emergency actuation position if an emergency actuation having an appropriately high emergency actuation force has be exerted thereon, in which emergency actuation position the door or the door latch is mechanically opened.

In the design of the door handle assembly, the invention provides that a clamping element is supported on the mount in a sliding manner, and a lock cylinder, serving to mechanically unlock a door latch of the door or hatch, or a lock cylinder dummy, is secured to the mount, wherein the handle forms a cover for the lock cylinder or the lock cylinder dummy when it is in the un-pivoted, normal actuation position, and wherein the clamping element can be moved between an installation position, in which the clamping element is not engaged with the lock cylinder or the lock cylinder dummy, and an operating position, in which the clamping element secures the lock cylinder or lock cylinder dummy in place on the mount. The clamping element can serve not only to secure the lock cylinder, but it can also serve to safeguard the lock cylinder, as protection against a break-in, in appropriate designs thereof. The handle is also used in this design as a cover for the lock cylinder.

In accordance with a first embodiment of the door handle assembly according to the invention, it is structurally particularly favorable when the mechanical retaining element comprises an elastic spring element, which is attached to the clamping element, and can be moved together therewith, wherein a first arm of the elastic spring element bears on a supporting lug of the clamping element or on a supporting lug formed on the mount. Because of the design as an elastic spring element, the return force can be precisely adjusted, which has a positive effect on the return force that is to be applied in an emergency. Furthermore, the use of an elastic spring element has economic advantages. When the door handle assembly is in use, it is essential that the first arm bears on a supporting lug that is stationary with respect to the handle, in order for the elastic spring element to be able to be compressed in accordance with is prescribed mode of action, in order to be able to exert its predetermined force in accordance with the operating state of the door handle assembly. Accordingly, the supporting lug can be formed on either the mount, or on the clamping element that is disposed such that it is stationary in relation to the stationary mount when in operation.

In the design of the first embodiment, the invention provides that a second arm of the elastic spring element is disposed in a supporting manner on an installation lug of the clamping element when in the installation position, and is disposed in an engaging manner on retaining stop formed on a second longitudinal end of the handle when in the operating position, wherein the elastic spring element forces the handle via the retaining stop into its normal actuation position with the predetermined return force when in the operating position. Alternatively thereto, it is also possible that a second arm of the elastic spring element is pre-fixed on the mount in the installation position, and is disposed in an engaging manner on a retaining stop formed on the second longitudinal end of the handle when in the operating position, wherein the elastic spring element forces the handle via the retaining stop into its normal actuation position with the predetermined return force, when in the operating position. The retaining element in the form of the spring element thus acts directly on the handle, and retains it in the normal actuation position during a normal actuation as well, such that the user has the impression that he actuates a stationary handle. For the installation, it is of particular advantage that the retaining element is disposed on the clamping element, and is slid along with the clamping element on the mount during the installation, by means of which the second arm of the spring element comes to bear on the second longitudinal end of the handle and exerts its return force on the second longitudinal end.

For an emergency actuation with the first embodiment, it is of particular advantage when the second longitudinal end of the handle has a latching recess, into which the second arm of the elastic spring element can be snapped in place when the handle is actuated with an emergency actuation force directed away from the mount, such that the handle is disposed such that it is retained in the emergency actuation position, and a mechanical key can be inserted into the lock cylinder. The handle is thus disposed such that it is lifted away from the mount, and enables an unimpeded access to the lock cylinder, without a user having to hold the handle in the emergency actuation position using excessive force, in order to insert the key into the lock cylinder in order to unlock it.

Lastly, it is structurally particularly beneficial in the first embodiment, when the handle is mechanically coupled to the door latch via a Bowden cable. As a result of this design, the force applied to the handle in an emergency, which must be greater than the predetermined return force of the retaining element, or the spring element, respectively, acts directly on the door latch.

In accordance with a second embodiment, it is provided that the handle is mechanically connected to the door latch via a pivot arm rotatably supported on the mount, and a Bowden cable connected to the pivot arm.

Accordingly, a different support for the retaining element is to be provided in the second embodiment, due to the pivot arm. The invention accordingly provides, in the second embodiment of the door handle assembly, that the mechanical retaining element comprises an elastic spring element, which is disposed between the mount and the pivot arm via a spring axle supported on the mount and the pivot arm, wherein a first spring end of the spring element bears on the mount. Because of the design as an elastic spring element, the return force can be adjusted very precisely, having a positive effect on the return force that is to be applied in an emergency. Furthermore, the use of an elastic spring element is economically beneficial.

For the further support of the elastic spring element, the invention in accordance with the second embodiment provides that a second spring end of the elastic spring element bears against the pivot arm in both the installation position as well as the operating position, wherein the clamping element brings the pivot arm into engagement with the second longitudinal end of the handle when it is moved from the installation position into the operating position. The pivot arm is thus moveably coupled to the clamping element in the second embodiment, such that a movement of the clamping element from the installation position into the operating position not only secures the lock cylinder on the mount, but also brings the handle and the pivot arm into engagement with one another.

In accordance with the different type of support in the second embodiment, the invention provides, in another design, that the elastic spring element forces the handle via the pivot arm into its normal actuation position with the predetermined return force when in the operating position, wherein the elastic spring element holds the pivot arm in engagement with the handle thereby. Primarily, the second spring end acts on the pivot arm such that it is retained in its starting position, in which the handle coupled to the pivot arm is retained in the normal actuation position, thus not pivoted outward, in the manner of a stationary handle.

In order to be able to release the door in an emergency, the invention provides in the second embodiment that the handle has a locking cap that has been attached such that it can be removed, which is flush with the lock cylinder, at its second longitudinal end, through which a mechanical key can be inserted into the lock cylinder when the locking cap has been removed.

In order to remove the locking cap, it is then advantageous when the handle has a hole at its second longitudinal end, through which a mechanical key can be inserted, in order to remove the locking cap.

Both for the first as well as for the second embodiment, it is provided in the design of the invention that the predetermined return force of the mechanical retaining element is set between at least sixty newtons and at most one hundred newtons. It is particularly preferred when the predetermined return force of the mechanical retaining element is eighty five newtons (85 N). As a result, it becomes evident that with a normal actuation force of the handle of at least ten newtons, the handle is to be regarded as stationary. The sensor electronics assembly is configured and designed such that it reacts to a normal actuation force of at least ten newtons. A lower force is not detected by the sensor electronics assembly, such that the door would not be opened electrically with this force, accordingly.

It is to be understood that the features specified above and still to be explained below may be used not only in the respective given combination, but also in other combinations or in and of themselves, without abandoning the scope of the present invention. The scope of the invention is defined only by the Claims.

### BRIEF DESCRIPTION OF THE DRAWINGS

Further details, features and advantages of the subject matter of the invention can be derived from the following description in conjunction with the drawings, in which exemplary preferred embodiment examples of the invention are depicted. Therein:

FIG. 1 shows a side view of a motor vehicle having numerous door handle assemblies according to the invention,

FIG. 2 shows a door of a motor vehicle having a door handle assembly,

FIG. 3 shows a schematic top view in a sectional view of a door handle assembly according to the invention in accordance with a first embodiment, having a handle in the normal actuation position, viewed looking at a locking device of the door handle assembly,

FIG. 4 shows a schematic top view in a sectional view of the door handle assembly in accordance with the first embodiment, for a first installation step of the handle on a mount,

FIG. 5 shows a schematic top view in a sectional view of the door handle assembly in accordance with the first embodiment for a second installation step of the handle on the mount,

FIG. 6 shows a schematic top view in a sectional view of the door handle assembly in accordance with the first embodiment for a third installation step of the handle on the mount,

FIG. 7 shows a schematic top view in a sectional view of the door handle assembly in accordance with the first embodiment, with the handle in the emergency actuation position,

FIG. 8 shows a schematic top view in a sectional view of the door handle assembly in accordance with a second embodiment, with a clamping element in the operating position,

FIG. 9 shows a schematic top view in a sectional view of the door handle assembly in accordance with the second embodiment, with the clamping element in the installation position, and

FIG. 10 shows a schematic sectional view, transverse to the door of the motor vehicle, of the door handle assembly in accordance with the second embodiment.

### DETAILED DESCRIPTION

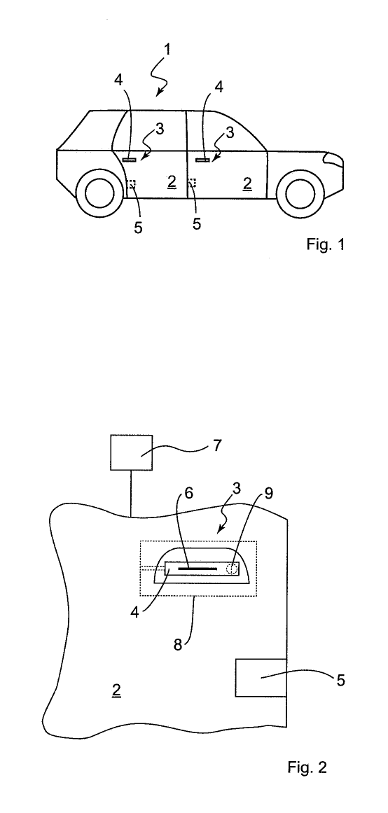

A vehicle, or motor vehicle 1, respectively, in the form of a passenger car is shown by way of example in FIG. 1, which has four doors 2 (two of which are visible in FIG. 1) in the example, which can be opened using a door handle assembly 3, and in particular using a door handle or handle 4. With reference to FIGS. 1 and 2, the doors 2 are closed via respective door latches, and can be opened from the outside via a respective actuation of the handle 4. The handle 4 has a handle part that can be grasped from behind, which can be actuated for opening the door latch 5, wherein the actuation in the depicted exemplary embodiments of FIGS. 1 to 12 is a pulling force of a user exerted on the handle 4, which is detected by a sensor electronics assembly 6 incorporated in the handle 4. In order to open the door 2, an electromechanical closing system 7 is then activated in normal operation, with which the door latch 2 can be opened or closed. The sensor electronics assembly 6 detects a force exerted on the handle part of the handle 4, of at least 10 N (ten newtons), and opens the door latch when such a force is detected, wherein the handle 4 remains un-pivoted on the door 2 with this actuation, and gives the user the impression that this is a stationary handle 4, which remains stationary at its position, despite the application of a pulling force. For the sensor electronics assembly 7, the various solutions are known from the prior art, which can also be used with the door handle assemble 3 according to the invention. Thus, for example, a switch, or a button, as well as a capacitive or inductive sensor, may be used on or in the handle 4. Because this concerns known measures, there shall be no detailed description of the sensor electronics assembly 7 included herein.

It is apparent from FIG. 2 that the handle 4 is disposed on the outside of the door 2 of the motor vehicle 1, wherein it can be grasped from behind by a user. A mount 8 designed in the manner of a frame is provided for coupling the handle 4 to the door 2, which is illustrated in FIG. 2 with a broken line, because it is disposed on the inside of the door 2, and is thus covered by the door 2 in FIG. 2. The mount 8 is attached to the inside of the door 2 via known fasteners, and supports the handle 4 disposed on the outside of the door 2. In other words, the mount 8 serves in the known manner for the installation of the handle 4, and is attached to the inside of the door 2 by means of threaded connections, not shown in detail, wherein the handle 4 is disposed on the outside of the door. The mount 8 is substantially formed by a frame structure thereby, in order to save on materials, which contains various receiving and supporting spaces, in order to be able to accommodate a lock cylinder 9, in addition to the handle 4, which is supported on the mount 7 for opening a corresponding door 2 of the motor vehicle 1 by a user. The handle 4 forms a cover thereby for the lock cylinder 9, and covers it, when it is in its un-pivoted position, which is a normal actuation position of the handle 4. For this reason, the lock cylinder 9 is likewise illustrated by a broken line in FIG. 2, as is the case with the mount 8. Instead of the lock cylinder 9 depicted in the Figures, however, a lock cylinder dummy can also be used in the door handle assembly 3.

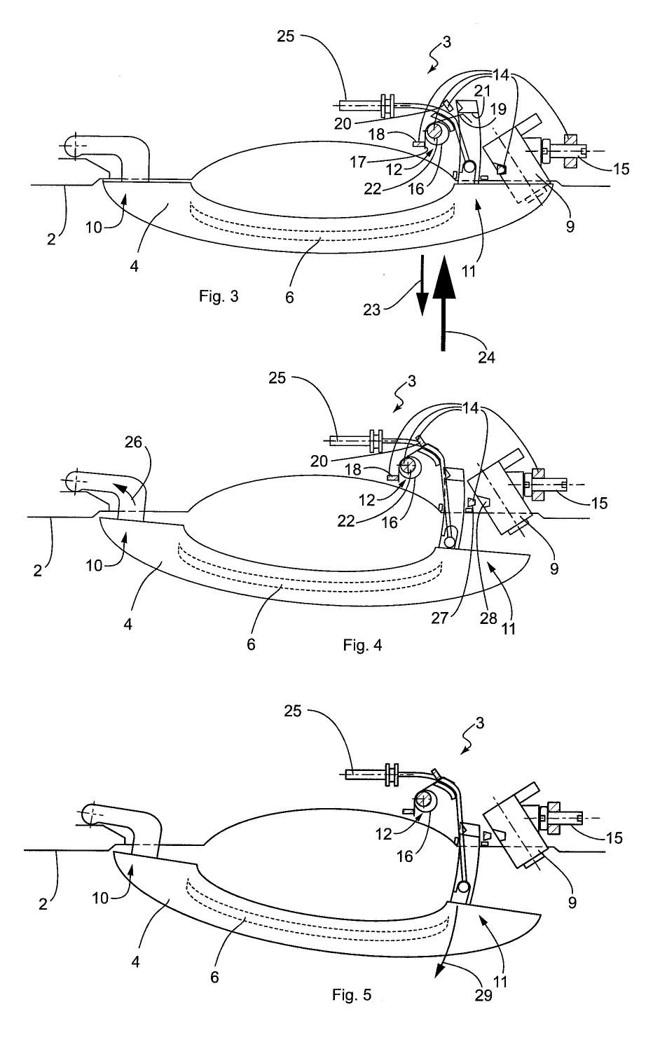

While in FIGS. 1 and 2 the door handle assembly 3 in accordance with the present invention is shown in a very general manner, a first embodiment is shown in FIGS. 3 to 7 based on concrete features, by means of which the door handle assembly 3 according to the invention is characterized. For reasons of clarity, both the mount 8 and the door latch 5, which can be opened both mechanically as well as electrically in accordance with the invention, are not shown in FIGS. 3 to 8.

FIG. 3 shows a schematic top view of the door handle assembly 3 in accordance with a first embodiment, wherein the door handle assembly 3 is located on the door 2 of the motor vehicle 1 in the installed state. In this installed state, a first longitudinal end 10 of the handle is pivotally supported on the mount 8, while in contrast, a second longitudinal end 11 of the handle 4 is coupled to the mount 8 such that the second longitudinal end 11 is moveably coupled to the mount 8, such that it can be pivoted away from the mount 8. Furthermore, the handle 4 assumes a normal actuation position in this installed state, in which it is retained by a mechanical retaining element 12. The mechanical retaining element 12 is supported in the first embodiment in a sliding manner on the mount 8 via a clamping element 14, wherein the clamping element 14 secures the lock cylinder 9 on the mount 8. In order to retain the handle 4 in its normal actuation position, which is shown in FIG. 3, the mechanical retaining element 12 exerts a predetermined retaining force toward the mount on the second longitudinal end 11 of the handle, which retains the handle 4 in the un-pivoted normal actuation position.

The clamping element 14 can be moved between an installation position, in which the clamping element 14 is not engaged with the lock cylinder 9 (see FIG. 4), and an operating position, in which the clamping element 14 secures the lock cylinder 9 on the mount 8 (see FIG. 3). The movement of the clamping element 15 on the mount 8 occurs through displacement of an adjustment means 15, which is designed as a screw, and bears against the lock cylinder 9, such that for installing or removing it, a rotation of the adjustment means 15, which is coupled to the clamping element 14 via a threaded connection, moves the clamping element 14 in relation to the adjustment means 15.

As can be derived from FIGS. 3 to 7, the mechanical retaining element 12 comprises an elastic spring element 16, which is attached to the clamping element 14, and can be moved therewith. A first arm 17 of the elastic spring element 16 bears against a supporting lug 18 of the clamping element 14. As a matter of course, it is also conceivable that the supporting lug 18 is formed not on the clamping element 14, but rather on the mount 8. In the installation position shown in FIG. 4, a second arm 19 of the elastic spring element 16 is disposed such that it is supported on an installation lug 20 of the clamping element 14, while in the operating position shown in FIG. 3, the second arm 19 is disposed such that it engages with a retaining lug 21 formed on the second longitudinal end 11 of the handle 4. For installation, the second arm 19 of the spring element 16 can alternatively also be pre-secured on the mount 8, as long as it is ensured that the second arm 19 engages with the second longitudinal end 11 of the handle 4 when in the operating position. More precisely stated, the second arm 19 of the spring element 16 presses against the retaining lug 21, which is formed on a hook-shaped lug of the handle. In this manner, the elastic spring element, which is wound about an axle 22 formed on the clamping element, and supported there, forces the handle 4 with its return force into its normal actuation position via the retaining lug 21.

In a normal operation of the door handle assembly 3, a user grasps the handle from behind, and pulls on it with a normal actuation force 23 (see FIG. 3), in order to be able to open the door. The sensor electronics assembly 6 detects this actuation of the handle 4 caused by the user, on which the normal actuation force acts, directed away from the mount 8. While the predetermined return force 24 of the retaining element 12, or the spring element 16, respectively, is selected such that it is powerful enough that it is substantially greater than the normal actuation force, and the handle 4 remains disposed in its normal actuation position when the handle 4 is actuated by a user.

Based on FIGS. 4, 5 and 6, the installation of the door handle assembly 3 according to the invention shall be described briefly below, by means of which the functioning and mode of action thereof shall become clearer.

FIG. 4 shows a first installation step for the door handle assembly 3. In this first installation step, the first longitudinal end 10 of the handle 4 is inserted in a bearing section formed on the mount 8 (see arrow 26 in FIG. 4), while the hook-shaped second longitudinal end 11 of the handle 4 is merely inserted into the mount 8. Furthermore, one end of a Bowden cable 25 used in an emergency, which is mechanically coupled to the door latch 5, is hooked in a corresponding receiver, which is formed in the second longitudinal end 11 of the handle 4. The clamping element 14 is in its installation position in FIG. 4, which it assumes by adjusting the adjustment means 15. The clamping element 14 is not engaged with the lock cylinder 9 in the installation position, in that a latching lug 27 formed on the clamping element 14 is pushed out of a latching lug receiver 28 formed in the outer surface of the lock cylinder 9. Furthermore, the elastic spring element 16, or the retaining element 12, respectively, is retained exclusively on the clamping element 14 when it is in the installation position, and can be slid together with the clamping element 14, because the second arm 19 bears against the installation lug 20.

A second installation step is shown in FIG. 5, which is characterized by a pulling movement exerted on the handle 4 in the direction of the arrow 29, thus forming an outward pivotal movement of the handle 4. The pulling of the handle 4 causes the spring mechanism to be released, which provides the Bowden cable 25 with a certain amount of freedom of motion for the installation, such that the Bowden cable 25 is only subjected to a certain amount of pre-tension, and as a result, is pulled into the receiver provided for it, which is formed on the second longitudinal end 11 of the handle 4.

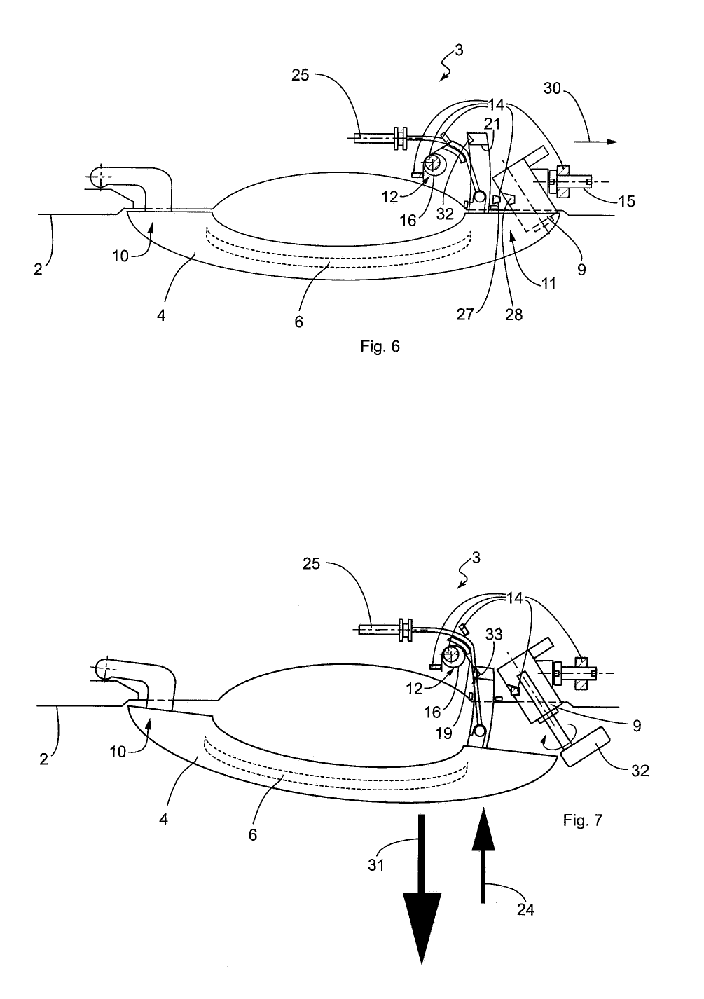

Because of this pre-tensioning, the handle 4 is now pulled into its normal actuation position, as is shown in FIG. 6. When the individually described components of the adjustment means 15 are then shifted to the position depicted in FIG. 6, the clamping element 15 is pushed along the mount 8 in the direction of the arrow 30, and assumes its operating position, which is shown in FIG. 3, and in which the lock cylinder 9 is engaged with the clamping element 14, while the latching lug 27 formed on the clamping element 14 engages in the latching lug receiver 28 formed in the lock cylinder 9. Not only is the lock cylinder 9 secured in the operating position on the mount 8 when the clamping element is moved from its installation position, the retaining element 12, which is designed as the elastic spring element 16, and more precisely as a yoke spring, engages with the retaining lug 21 of the handle 4 at its second longitudinal end 11. In other words, when the clamping element 14 is moved from its installation position into the operating position, the second arm 19 of the spring element 16 comes to bear on the retaining lug 21, by means of which the installation of the door handle assembly 3 is completed, and the door handle assembly 3 exhibits the arrangement of the components describe above, shown in FIG. 3.

In an emergency, in which the entire vehicle system of the motor vehicle 1 is without power, and the electromechanical latching system 7 is no longer able to function, a mechanical opening of the door 2 can be achieve by an actuation of the handle 4. For this, the handle 4 must be actuated with an emergency actuation force directed away from the mount 8 (see arrow 31), which is greater than the predetermined return force 12, as is depicted in FIG. 7. By pivoting the handle 4 with the emergency actuation force, the handle 4 ends up in the emergency actuation position shown in FIG. 7, wherein with this movement, the handle acts on the door latch 5 via the Bowden cable 25, thus mechanically opening the door 2. In the event of a vehicle collision, a safety mechanism is provided, which ensures that the lock cylinder 9 is automatically unlocked. In the event, however, that there is no electrical power, and no collision has occurred, then the lock cylinder 9 must first be unlocked using a mechanical emergency key 32, before the door 2 can be opened. In order to not have to hold the handle 4 with the emergency actuation force 31 to obtain an unobstructed access to the lock cylinder 9, the handle 4 can be mechanically held in the emergency actuation position. For this, the second longitudinal end 12 of the handle 4 has a latching recess 33, into which the second arm 19 of the elastic spring element 16 can be snapped when the handle 4 is actuated with an emergency actuation force 31 directed away from the mount 8, such that the handle 4 is held in place in the emergency actuation position, as is shown in FIG. 7. A mechanical emergency key 32 can then be easily inserted into the lock cylinder 9 in the emergency actuation position, and the lock cylinder 9 can be unlocked, in order to then push the handle back toward the mount 4 in a second step, in order to then again pivot the handle 4 with the emergency actuation force 31, in order to mechanically open the door 2 via the Bowden cable 25.

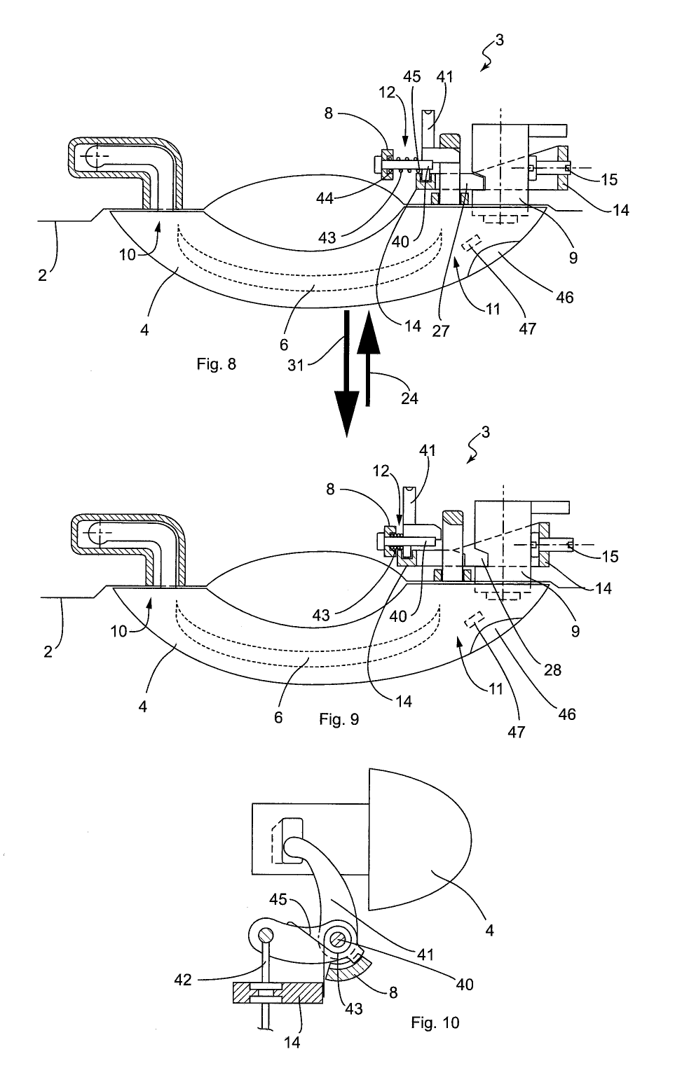

FIGS. 8, 9 and 10 show a second embodiment of the door handle assembly 3 according to the invention. Where the same reference symbols are used in the Figures of the second embodiment as those used in the first embodiment, they relate to identical or the same components, such that reference is made to the description above for the first embodiment, and this description also applies to the second embodiment.

In FIG. 8, a schematic top view of the door handle assembly 3 in accordance with the second embodiment is shown, wherein the door handle assembly 3 is located in the installed state on the door 2 of the motor vehicle 1 therein. As with the first embodiment, a first longitudinal end 10 of the handle 4 is also pivotably supported on the mount 8 for the installed state here, while in contrast, a second longitudinal end 11 of the handle 4 is coupled to the mount 8 such that the second longitudinal end 11 is moveably coupled to the mount 8 such that it can be pivoted away from the mount. Here as well, the handle 4 assumes a normal actuation position in this installed state, in which it is retained by a mechanical retaining element 12, and forms a cover for the lock cylinder 9. The clamping element 14 supported in a sliding manner on the mount 8 also secures the lock cylinder 9 on the mount 8 here in the second embodiment.

In differing from the first embodiment, the mechanical retaining element 12 in the second embodiment is disposed about an axle 40, which is formed on the mount 8. Furthermore, the second embodiment differs from the first embodiment in that the handle 4 is mechanically connected to the door latch 5 via a rotatably supported pivot arm 41 and a Bowden cable 42 connected to the pivot arm 41 (see FIG. 10). With the second embodiment, the mechanical retaining element 12 also exerts the predetermined retaining force toward the mount 8 on the second longitudinal end 11 of the handle 4, which retains the handle 4 in the un-pivoted normal actuation position.

The clamping element 14 supported in a sliding manner on the mount 8, of which only the respective visible lugs for the shown section are depicted in FIGS. 8, 9 and 10, is disposed in its operating position in FIG. 8, in which it secures the lock cylinder 9 on the mount 8, in that the latching lug 27 of the clamping element 14 is engaged in the latching lug receiver 28 formed in the lock cylinder 9. FIG. 9 shows the clamping element 14 in its installation position, in which it, or its latching lug 27, respectively, is not engaged with the lock cylinder 9, or its latching lug receiver 28.

A further difference of the second embodiment in comparison with the first embodiment is that the mechanical retaining element 12 is designed as an elastic spring element 43, which is slid onto the spring axle 40 held in place on the mount 8, and is disposed between the mount 8 and the pivot arm 41. A first spring end 44 of the spring element 43 bears against the mount 8 thereby. The second spring end 45 of the elastic spring element 43 bears against the pivot arm 41 in both the installation position of the clamping element 14 (see FIG. 9) as well as in the operating position of the clamping element 14 (see FIG. 8), wherein the clamping element 14 brings the pivot arm 41 into engagement with a hook-shaped lug formed on the second longitudinal end 11 of the handle 4 when it moves from the installation position into the operating position.

As is apparent from an overview of FIGS. 8, 9 and 10, the elastic spring element 43 in the second embodiment then forces the handle 4 with the predetermined return force 24 into the normal actuation position via the pivot arm 41, when the clamping element 14 is disposed in the operating position (see FIG. 8). The elastic spring element 43 also holds the pivot arm 41 pressed in engagement with the handle 4 thereby. As can be derived from a comparison of FIGS. 8 and 9, the axle 40 can be displaced in relation to the pivot arm 41, wherein the pivot arm 41 is also moveably coupled to the clamping element 14, because when the clamping element 14 is moved from the installation position into the operating position, only the pivot arm 41, together with the clamping element 14, is displaced, but not the axle 40 or the spring element 43.

The mode of action of the door handle assembly 3 in the second embodiment is substantially identical to the mode of action of the first embodiment. The substantial difference is that the elastic spring element 43 does not act directly on the handle 4, but rather, it holds the handle 4 in the emergency actuation position indirectly, via the pivot arm 41, such that in an emergency, the handle 4 is first then pivoted away from the mount 8 and the door can be opened in a purely mechanical manner, when the handle 4 is pulled on with an emergency actuation force, which is greater than the return force 24 exerted by the elastic spring element 43 on the handle 4. Then, in an emergency in which the vehicle system has no power, the door 2 can be opened mechanically through an actuation of the handle 4, whereas in normal operation, the handle 4 remains stationary on the door, and thus un-pivoted, when actuated with the normal actuation force. With the second embodiment as well, in an emergency the handle 4 must be actuated with the emergency actuation force directed away from the mount 8 (see arrow 31), which is greater than the predetermined return force 12, as is depicted in FIG. 8. By pivoting the handle 4 with the emergency actuation force, the handle 4 arrives in an emergency actuation position, not shown for the second embodiment. With this movement, the handle 4 acts on the door latch 4 via the Bowden cable 42 attached to the pivot arm 41, by means of which the door 2 can be mechanically opened. In order to unlock the lock cylinder 9 using a mechanical key 32, the handle 4 has a locking cap 46 on its second longitudinal end 11, which is flush with the lock cylinder 9, and can be removed from the handle. When the locking cap 46 has been removed from, or taken off of, the handle 4, a mechanical key 32 can be inserted into the lock cylinder 9 through the passage that has been opened in the handle 4, in order to unlock it. In order to aid in the removal of the locking cap 46, the handle 4 has an additional opening 47 at its second longitudinal end 11, which is accessible to a user from the outside, and through which the mechanical key 32 can be inserted in order to remove the locking cap 46. After the unlocking, the handle 4 can then be pivoted with the emergency actuation force 31, in order to mechanically open the door 2 via the pivot arm 41 and the Bowden cable 42.

Both for the first as well as the second embodiment, the predetermined return force 24 of the mechanical retaining element 12 lies between at least sixty newtons and at most one hundred newtons, wherein the normal actuation force of the handle 4 is at least ten newtons.

In summary, a door handle assembly 3 for a motor vehicle 1 is described with the present invention, which is distinguished by a pseudo-stationary handle 4. The expression “pseudo-stationary” means, in conjunction with the invention, that the handle 4 exhibits no mechanical functional chain in normal operation, but rather, the unlatching occurs solely through the electromechanical locking system 7, which is activated when an actuation of the handle 4 is detected by the sensor electronics assembly 6. The handle 4 can only be pivoted in an emergency, in which a electrically powered opening of the door is not possible, wherein an actuation force is necessary for this, which is much greater the normal actuation force, and which overcomes the return force 24 of the retaining element 12. Accordingly, it is characteristic for the present invention that the mechanical retaining element 12 exerts the predetermined retaining force 24 toward the mount 8 on the second longitudinal end 11 of the handle 4, and retains the handle 4 in the un-pivoted normal actuation position, wherein the sensor electronics assembly 6 opens the door 2 or hatch electrically when an actuation of the handle 4 by a user with a normal actuation force 23 directed away from the mount 8, which is lower than the predetermined return force 24, is detected, and the handle 4 remains disposed thereby in its normal actuation position. The handle 4 can be pivoted into an emergency actuation position when the handle 4 is actuated with an emergency actuation force 31 directed away from the mount 8, which is greater than the predetermined return force 24, in which the pivotal movement of the handle 4 mechanically opens the door 2 or the hatch.

As a matter of course, the invention described above is not limited to the described and illustrated embodiments. It is apparent that numerous modifications, obvious to the person skilled in the art concerning the intended use, can be made to the embodiments depicted in the drawings, without abandoning the scope of the invention thereby. Everything contained in the description and/or depicted in the drawings, including that which deviates from the concrete exemplary embodiments, but which is obvious to the person skilled in the art, belongs to the invention thereby.

1. A door handle assembly of a motor vehicle, comprising:
a mount that is adapted to be attached to a door or hatch of the motor vehicle and designed in the manner of a frame,
a handle that is adapted to be disposed on the outside of the door or hatch of the motor vehicle, which can be grasped by a user from behind,
a door latch of the door or hatch of the motor vehicle, which is adapted to be activated mechanically as well as electrically, and opened, and
a sensor electronics assembly for detecting an actuation of the handle by a user,
wherein a first longitudinal end of the handle is pivotably supported on the mount, and a second longitudinal end of the handle is coupled to the mount such that it can be pivoted away from the mount, wherein a mechanical retaining element attached to the mount exerts a predetermined retaining force toward the mount on the second longitudinal end of the handle, and retains the handle in an un-pivoted, normal actuation position, wherein the sensor electronics assembly opens the door or hatch electrically when an actuation of the handle by a user with a normal actuation force directed away from the mount is detected, which is lower than the predetermined return force, and the handle remains disposed in its normal actuation position thereby, wherein the handle is adapted to be pivoted into an emergency actuation position when the handle is actuated with an emergency actuation force directed away from the mount, which is greater than the predetermined return force, in which the pivotal movement of the handle opens the door or hatch mechanically.

2. The door handle assembly according to claim 1, wherein a clamping element is supported in a sliding manner on the mount and a lock cylinder serving to mechanically release a door latch of the door or hatch, or a lock cylinder dummy, is secured on the mount, wherein the handle forms a cover for the lock cylinder or the lock cylinder dummy when it is in the un-pivoted normal actuation position, and wherein the clamping element can be moved between an installation position, in which the clamping element is not engaged with the lock cylinder or the lock cylinder dummy, and an operating position, in which the clamping element secures the lock cylinder or the lock cylinder dummy on the mount.

3. The door handle assembly according to claim 2, wherein the mechanical retaining element comprises an elastic spring element, which is attached to the clamping element and is adapted to be moved therewith, wherein a first arm of the elastic spring element bears against a supporting lug of the clamping element or a supporting lug formed on the mount.

4. The door handle assembly according to claim 3, wherein a second arm of the elastic spring element is disposed in a bearing manner on the installation lug of the clamping element when in the installation position, and is disposed such that it engages with a retaining lug formed on the second longitudinal end of the handle when in the operating position, wherein the elastic spring element forces the handle into its normal actuation position with the predetermined return force, via the retaining lug, when in the operating position.

5. The door handle assembly according to claim 2, wherein a second arm of the elastic spring element is pre-secured on the mount in the installation position, and is disposed such that it engages with a retaining lug formed on the second longitudinal end of the handle when in the operating position, wherein the elastic spring element forces the handle with the predetermined return force into its normal actuation position via the retaining lug, when in the operating position.

6. The door handle assembly according to claim 4, wherein the second longitudinal end of the handle has a latching recess, into which the second arm of the elastic spring element can be snapped in place when the handle is actuated with an emergency actuation force directed away from the mount, such that the handle is retained in the emergency actuation position, and a mechanical key can be inserted into the lock cylinder.

7. The door handle assembly according to claim 2, wherein the handle is mechanically coupled to the door latch via a Bowden cable.

8. The door handle assembly according to claim 2, wherein the handle is mechanically connected to the door latch via a pivot arm pivotally supported on the mount, and a Bowden cable connected to the pivot arm.

9. A door handle assembly according to claim 8, wherein the mechanical retaining element comprises an elastic spring element, which is disposed between the mount and the pivot arm via a spring axle supported on the mount and the pivot arm, wherein a first spring end of the spring element bears against the mount.

10. The door handle assembly according to claim 9, wherein a second spring end of the elastic spring element bears against the pivot arm in both the installation position as well as in the operating position, wherein the clamping element brings the pivot arm into engagement with the second longitudinal end of the handle when it moves from the installation position into the operating position.

11. The door handle assembly according to claim 9, wherein the elastic spring element forces the handle into its normal actuation position with the predetermined return force, via the pivot arm, when in the operating position, wherein the elastic spring element holds the pivot arm pressed into engagement with the handle thereby.

12. The door handle assembly according to claim 8, wherein the handle includes a locking cap at its second longitudinal end that is flush with the lock cylinder, and is attached thereto such that it is adapted to be removed, through which a mechanical key is adapted to be inserted into the lock cylinder when the locking cap has been removed.

13. The door handle assembly according to claim 12, wherein the handle includes a hole at its second longitudinal end, through which a mechanical key is adapted to be inserted in order to remove the locking cap.

14. The door handle assembly according to claim 1, wherein the predetermined return force of the mechanical retaining element lies between at least sixty newtons and at most one hundred newtons.

15. The door handle assembly according to claim 1, wherein the normal actuation force of the handle is at least ten newtons.
